(19) United States
(12) Patent Application Publication
(10) Pub. No.: US 2016/0129671 A1
(43) Pub. Date: May 12, 2016

(54) RESIN LAMINATED BODY

(71) Applicant: TOYOTA JIDOSHA KABUSHIKI KAISHA, Toyota-shi (JP)

(72) Inventor: Masaya MIURA, Toyota-shi (JP)

(73) Assignee: TOYOTA JIDOSHA KABUSHIKI KAISHA, Toyota-shi (JP)

(21) Appl. No.: 14/933,812

(22) Filed: Nov. 5, 2015

(30) Foreign Application Priority Data
Nov. 7, 2014 (JP) 2014-227098

(51) Int. Cl. B32B 7/14

(52) U.S. Cl. CPC B32B 7/14; B32B 2605/003; B32B 2262/106; B32B 2260/046

(57) ABSTRACT

Provided is a resin laminated body including a resin plate member and a resin skin member that is stretchable more than the resin plate member and is bonded to the resin plate member via an adhesion layer, the resin laminated body having a simple configuration, which is capable of preventing the exposure of an edge of a broken part to the outside effectively. A resin laminated body 10 includes: a resin plate member 1; and a resin skin member 2 that is stretchable more than the resin plate member 1 and is bonded to the resin plate member via an adhesion layer 3. The adhesion layer 3 includes a weak adhesiveness part 3b having a relatively small adhesiveness than other parts.

### CLAIM OF PRIORITY

The present application claims priority from Japanese patent application JP 2014-227098 filed on Nov. 7, 2014, the content of which is hereby incorporated by reference into this application.

### BACKGROUND

1. Technical Field

The present invention relates to a resin laminated body including a resin plate member, and a resin skin member that is stretchable more than the resin plate member and is bonded to the resin plate member via an adhesion layer.

2. Background Art

Fiber-reinforced resin members (fiber-reinforced plastics (FRPs)) containing a reinforcement fiber material (fiber-reinforced material) in resin are light-weighted and strong, and so they are used in various industries, such as automobile, construction and aviation. For instance, the automobile industry uses the fiber-reinforced resin members as structural members of vehicles, such as a front-side member, a center cross member, a pillar, a rocker and a floor of the body or as non-structural members that are required to have a feature in design, such as a door outer panel and a hood. Attempts then have been made to produce fuel-efficient and environment-friendly vehicles by keeping enough strength of the vehicle while reducing the weight.

Among these components of a vehicle, an interior panel for vehicle, for example, may be deformed partly at the time of collision of the vehicle and may lead to a breakage. Patent Document 1 discloses an interior panel for vehicle capable of preventing an edge of such a breakage (this is called a sharp edge, which is an edge where the broken projection protrudes) from being exposed to the interior of the vehicle. Specifically, the interior panel for vehicle is configured so that, between the surface of a panel main body and a first film, a second film that is in intimate contact with the surface of the panel main body and being more stretchable than the first film is disposed.

In this way, the interior panel for vehicle described in Patent Document 1 includes two types of films bonded to the panel main body, and so if secondary collision occurs following the collision of the vehicle so that a head, for example, of a passenger collides with an instrumental panel and the panel main body brakes, the second film partially expands at a peripheral part of the breakage, which can keep the state where the surface of the panel main body is coated with the second film, and so can prevent the exposure of an edge (sharp edge) of the broken part of the panel main body.

This configuration, however, needs improvement for material cost and manufacturing efficiency because the interior panel has to be manufactured using two types of films including the first film and the second film.

### RELATED ART DOCUMENTS

### Patent Document

Patent Document 1: JP 2011-105093 A

### SUMMARY

In view of the above-stated problems, the present invention relates to a resin laminated body including a resin plate member and a resin skin member that is stretchable more than the resin plate member and is bonded to the resin plate member via an adhesion layer, and aims to provide a resin laminated body having a simple configuration, which is capable of preventing the exposure of an edge of a broken part to the outside effectively.

To fulfill the aforementioned object, a resin laminated body of the present invention includes: a resin plate member; and a resin skin member that is stretchable more than the resin plate member and is bonded to the resin plate member via an adhesion layer. The adhesion layer includes a weak adhesiveness part having a relatively small adhesiveness than other parts.

The resin laminated body of the present invention has a simple configuration including a resin plate member and a resin skin member that is relatively stretchable and is bonded to the surface of the resin plate member via an adhesion layer, and basically includes one resin skin member. In this way, the resin laminated body has a technical feature that it includes one resin skin member and the adhesion layer is made up of parts each having different adhesiveness and includes a weak adhesiveness part having a relatively small adhesiveness compared with other parts so as to prevent the exposure of a sharp edge to the outside that occurs when the resin plate member making up the resin laminated body breaks during collision or the like.

In this way, the adhesion layer includes a weak adhesive part, whereby when the resin plate member breaks, the adhesion state of the resin plate member and the resin skin member is canceled at least at the weak adhesiveness part, and they are peeled off mutually.

In this point, a conventional interior panel includes a resin plate member (panel main body) and a resin skin member (film) that are bonded to have uniform adhesiveness at the entire face. Then, if the resin plate member breaks, the resin skin member at a part corresponding to the broken part also tears, meaning that a sharp edge as an edge of the breakage of the resin plate member will be exposed to the outside.

While two divided pieces of the resin plate member are mutually connected in the state where they are boned to the resin skin member, the sharp edges of the two divided pieces are surrounded with the resin skin member, and so the exposure to the outside can be avoided. When the resin laminated body having a simple configuration including a resin plate member and a resin skin member that is bonded to the surface of the resin plate member via an adhesion layer is used as a structural body of a vehicle or the like, the resin skin member is a member having design, for example, and so in the “exposure to the outside”, “the outside” is the side of an observer (e.g., in the case where the resin laminated body is an interior panel for vehicle, a passenger) who views the resin laminated body, and the “exposure to the outside” means that a sharp edge is exposed to the observer side.

Since the resin skin member is more stretchable than the resin plate member, even if the resin plate member breaks and is divided into two divided pieces, for example, the resin skin member can be extended so as to avoid its breakage by absorbing an impact during the breakage of the resin plate member. This can avoid the exposure to the outside of a sharp edge of the divided pieces.

The “resin plate member” may be a plate member made of thermoplastic resin or thermosetting resin, which includes a plate member containing a fiber-reinforced material or a plate member not containing a fiber-reinforced material. The fiber-reinforced material may include a continuous fiber-reinforced material, a long fiber-reinforced material, and a short fiber-reinforced material. The plate member may have any shape, including a narrow straight plate, a narrow curved plate, a narrow plate including a straight part and a curved part, a wide flat plate, a wide curved plate, a wide plate including a flat part and a curved part, and the like. Exemplary thermoplastic resin of the plate member includes crystalline plastics such as polyamide (PA) and polypropylene (PP) and non-crystalline plastics such as polystyrene (PS) and polyvinyl chloride (PVC). Exemplary thermosetting resin includes epoxy resin. Exemplary materials of the fiber-reinforced material include ceramic fiber, inorganic fiber such as carbon fiber, metal fiber and organic fiber, and the fiber-reinforced material may be made of any one type of the foregoing or two types or more of the foregoing that are mixed. Exemplary resin plate member includes CFRP and GFRP, among which CFRP is preferable.

The “resin skin member” used may be acrylic film, olefin film, olefin elastomer film and the like, among which olefin film and olefin elastomer film having excellent stretching property are preferable. The resin skin member desirably has breaking extension of 400% or more. Some resin plate members such as FRP have breaking extension of 2% or less.

Adhesive making up the “adhesion layer” used may be acrylic adhesive, epoxy adhesive or the like. In order to form a “weak adhesiveness part” and a “normal adhesiveness part” at other parts in the adhesion layer, one type of adhesive that is dissolved in solvent may be applied, for example. In this method, the content of the adhesive may be changed, whereby the “weak adhesiveness part” and the “normal adhesiveness part” can be formed. Alternatively, the “weak adhesiveness part” and the “normal adhesiveness part” may be formed by using two types of adhesives each having different adhesiveness. For instance, Cemedine (registered trademark) epoxy adhesives 1500, EP007 and EP330 have shear strength of 12.3 MPa, 8.0 MPa, and 3.9 MPa, respectively, when FRP is to be bonded.

Alternatively, one type of adhesive is used, and a part of the resin plate member corresponding to the “weak adhesiveness part” may have a smooth surface without unevenness, and a part corresponding to the “normal adhesiveness part” may have a surface with unevenness. In this configuration, the “normal adhesiveness part” has adhesiveness of the adhesive that is increased due to anchor effect from this unevenness, and as a result, a “weak adhesiveness part” can be formed.

Still alternatively, the “weak adhesiveness part” does not include an adhesive therein, which may be a “weak adhesiveness part” having adhesiveness of zero.

In this way, there are various forms of the weak adhesiveness part of the adhesion layer, and such a weak adhesiveness part may be disposed in various forms, e.g., the weak adhesiveness part may be disposed at one part of a center region of the adhesion layer, at a plurality of parts of the center region of the adhesion layer, and at a plurality of parts with regular intervals at the entire region of the adhesion layer.

The resin laminated body of the present invention basically includes one resin plate member and one resin skin member that are bonded via an adhesion layer (which does not eliminate the form including two resin skin members completely, but there is no need to include two resin skin members), and simple improvement in configuration internally including a weak adhesiveness part at the adhesion layer can effectively prevent the exposure of an edge (sharp edge) to the outside when the resin plate member breaks.

When the resin laminated body is narrow, long and thin, a part around the center is greatly plastic-deformed when an impact is imposed, and such deformation often progresses and leads to a breakage. When the resin laminated body is wide and has a sheet form as well, a part around the center is greatly plastic-deformed, and such deformation often and early leads to a breakage. Then, a weak adhesiveness part is formed at such a part where bending easily occurs when the resin laminated body undergoes bending deformation, whereby a weak adhesiveness part located at the part where the resin plate member easily breaks can easily exert the advantageous effect of the resin laminated body of the present invention, and so such a configuration is preferable.

The resin laminated body of the present invention is applicable to various structural bodies, and is preferably applicable to an interior panel for vehicle because it can avoid the exposure of a sharp edge to the outside when the resin plate member of the resin laminated body is broken, and so can protect a passenger inside of the vehicle. Such an interior panel for vehicle may be a front pillar, a roof side rail, a front pillar garnish, or the like.

As can be understood from the above descriptions, the resin laminated body of the present invention includes a resin plate member and a resin skin member that is bonded to the resin plate member via an adhesion layer, and the adhesion layer includes a weak adhesiveness part having a relatively small adhesiveness than other parts. In this way, while the resin laminated body has a simple configuration, the resin skin member can prevent the exposure to the outside of an edge at a broken part effectively.

### BRIEF DESCRIPTION OF THE DRAWINGS

FIG. 1 is a perspective view of one embodiment of a resin laminated body of the present invention.

FIG. 2 is a view taken along the line II-II of FIG. 1, describing Embodiment 1 of an adhesion layer.

FIGS. 3A and 3B illustrate Embodiments 2 and 3, respectively, of the adhesion layer.

FIG. 4 describes the state where a load acts on the resin laminated body, and a breakage occurs at the resin plate member.

FIGS. 5A, 5B and 5C describe how to calculate the adhesiveness at a weak adhesiveness part so as to prevent the external exposure of a sharp edge generated when the resin plate member breaks, where FIG. 5A describes the state where a load acts on the center position of a verification model, FIG. 5B describes a y-z cross section of the verification model, and FIG. 5C describes a cross-sectional force at a x-y cross section of the verification model.

### DETAILED DESCRIPTION OF THE EMBODIMENT(S)

The following describes embodiments of a resin laminated body of the present invention, with reference to the drawings. Needless to say, while the drawings illustrate a straight member that is narrow, long and thin as a resin laminated body, the resin laminated body may be a curved member that is narrow, a member that is narrow, including a straight part and a curved part, a wide member and the like.

### One Embodiment of Resin Laminated Body

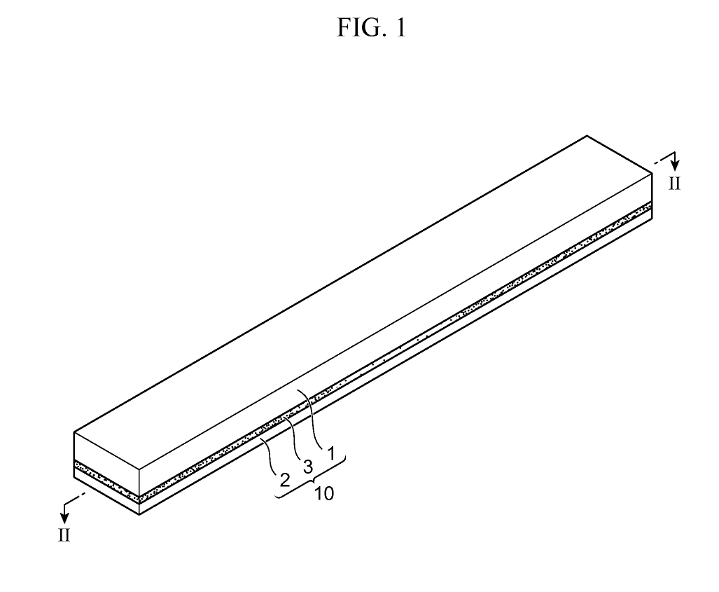

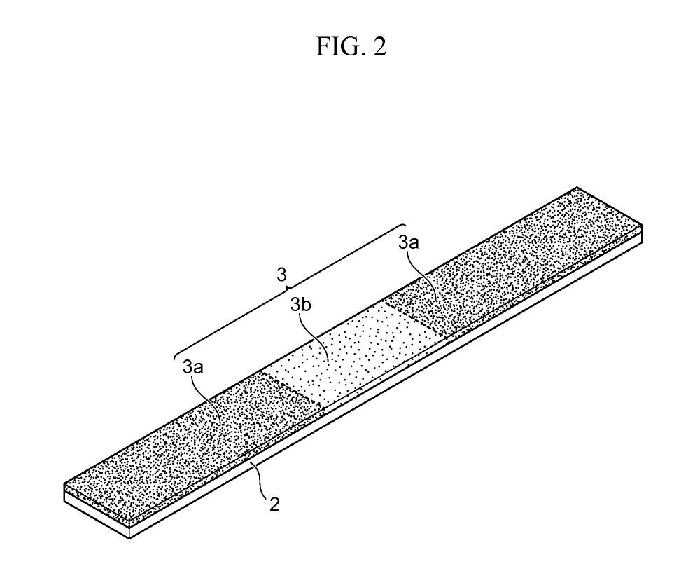

FIG. 1 is a perspective view of one embodiment of a resin laminated body of the present invention, and FIG. 2 is a view taken along the line II-II of FIG. 1, describing Embodiment 1 of an adhesion layer.

A resin laminated body 10 illustrated as the overall structure includes a resin plate member 1 and a resin skin member 2 that is stretchable more than the resin plate member 1 that are bonded via an adhesion layer 3.

The adhesion layer 3 of Embodiment 1 in FIG. 2 has a weak adhesiveness part 3b at a part corresponding to a center region of the resin laminated body 10, the weak adhesiveness part having relatively small adhesiveness than other parts (normal adhesiveness parts 3a in the left and right surrounding regions). Herein a breakage likely occurs in the resin plate member 1 under the designed load at the “center region of the resin laminated body 10” where the weak adhesiveness part 3b is to be formed, and such a region may be set by a designer.

When external force acts on the resin laminated body 10, the resin laminated body 10 tends to be plastic-deformed mainly at the center region, and such plastic deformation progresses to lead a breakage typically. Then as illustrated in the drawing, the weak adhesiveness part 3b is disposed at a part of the adhesion layer 3 corresponding to the center region of the resin laminated body 10, whereby if plastic deformation progresses at the center region and a breakage occurs at the center region, the resin skin member 2 easily peels off from the resin plate member 1 at the weak adhesiveness part 3b at the part where the breakage occurs, which can solve the problem of a tear of the resin skin member 2 due to a breakage of the resin plate member 1.

Note here that when a breakage of the resin plate member 1 under the designed load likely occurs at any one of the left and right surrounding regions, instead of the center region, the weak adhesiveness part 3b may be formed at such a surrounding region.

The resin plate member 1 is a plate member made of thermoplastic resin or thermosetting resin, which includes a plate member containing a fiber-reinforced material or a plate member not containing a fiber-reinforced material. When the plate member contains a fiber-reinforced material, such a fiber-reinforced material may include a continuous fiber-reinforced material, a long fiber-reinforced material, and a short fiber-reinforced material.

Exemplary thermoplastic resin of the resin plate member 1 includes crystalline plastics such as polyethylene (PE), polypropylene (PP), polyamide (PA: nylon 6, nylon 66, and the like), polyacetal (POM), and polyethylene terephthalate (PET), and non-crystalline plastics such as a polystyrene (PS), polyvinyl chloride (PVC), polymethyl methacrylate (PMMA), ABS resin, and thermoplastic epoxy, and the thermoplastic resin may be made of any one type of the foregoing or two types or more of the foregoing that are mixed. Exemplary thermosetting resin includes epoxy resin, phenol resin, and unsaturated polyester resin.

The fiber-reinforced material preferably includes a continuous fiber-reinforced material having a fiber length of 50 mm or more, or a long fiber-reinforced material having a fiber length less than 50 mm, which is longer than 10 mm and is about 30 mm or less, because such a fiber-reinforced material can form a strong member. Exemplary materials of the fiber-reinforced material include ceramic fiber such as boron, alumina, silicon carbide, silicon nitride, or zirconia, inorganic fiber such as glass fiber or carbon fiber, metal fiber such as copper, steel, aluminum, or stainless steel, and organic fiber such as polyamide or polyester, and the fiber-reinforced material may be made of any one type of the foregoing or two types or more of the foregoing that are mixed.

The normal adhesiveness part 3a and the weak adhesiveness part 3b making up the adhesion layer 3 can be different in adhesiveness because adhesives made of different materials are used for them. For instance, epoxy-based Cemedine adhesive 1500 (adhesiveness: 12.3 MPa) may be used for the normal adhesiveness part 3a, and epoxy-based Cemedine adhesive EP007 (adhesiveness: 8.0 MPa) may be used for the weak adhesiveness part 3b. Alternatively, epoxy-based Cemedine adhesive EP007 (adhesiveness: 8.0 MPa) may be used for the normal adhesiveness part 3a, and epoxy-based Cemedine adhesive EP330 (adhesiveness: 3.9 MPa) may be used for the weak adhesiveness part 3b.

In another method, one type of adhesive is used, which is mixed in solvent, and such a mixture may be applied, for example, to the resin plate member 1 to form the adhesion layer 3. In this method, the content of the adhesive in the solvent is less for the weak adhesiveness part 3b than for the normal adhesiveness part 3a, whereby the weak adhesiveness part 3b can be formed.

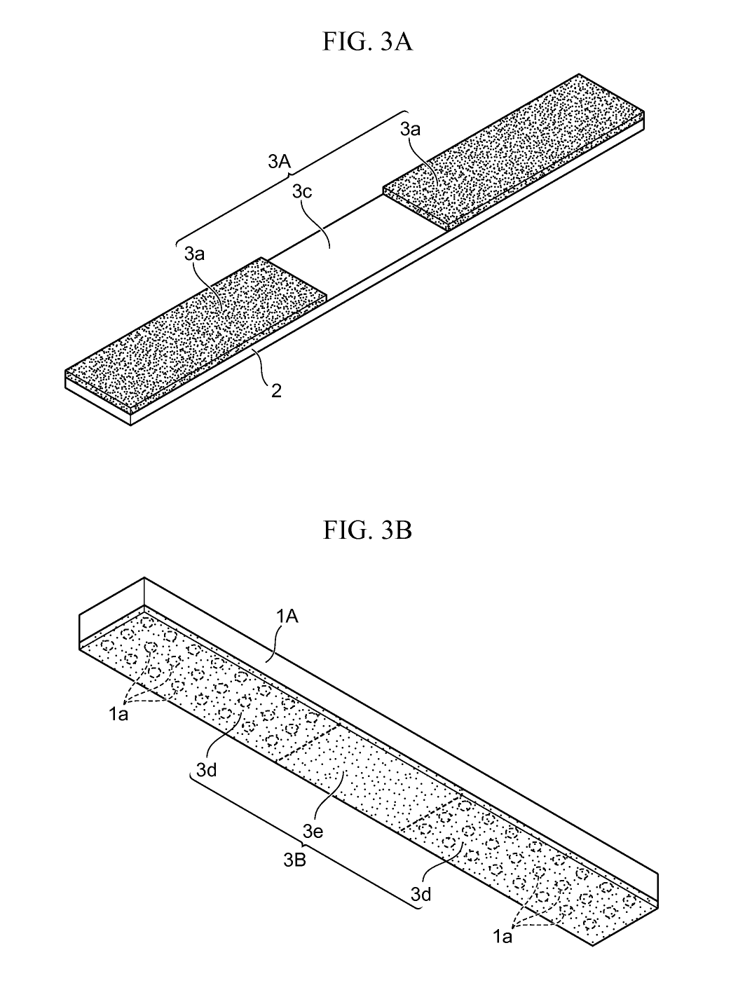

FIG. 3A, b illustrates other embodiments 2 and 3 of the adhesion layer.

The adhesion layer 3A in FIG. 3A has a space between the left and right normal adhesiveness parts 3a, where no adhesive is applied, and such a space without adhesive serves as a weak adhesiveness part 3c.

FIG. 3B is a view from the direction opposite to FIG. 2 and FIG. 3A (viewing the side of the resin plate member 1 that is opposite to the view taken along II-II of FIG. 1), having a plurality of projections 1a at the left and right surrounding regions of the resin plate member 1 to form an uneven surface there, while having no projections on the surface of the center region of the resin plate member 1 to form a flat surface. Then one type of adhesive is applied to the entire surface of the resin plate member 1 to form an adhesion layer 3B, whereby the projections 1a are embedded in the adhesion layer at the left and right surrounding regions of the adhesion layer 3B, which can be a normal adhesiveness part 3d having relatively large adhesiveness due to the anchor effect. On the other hand, since the surface at the center region of the resin plate member 1 does not have projections 1a and is flat, an adhesion layer formed on such a flat surface can be a weak adhesiveness part 3e having relatively small adhesiveness.

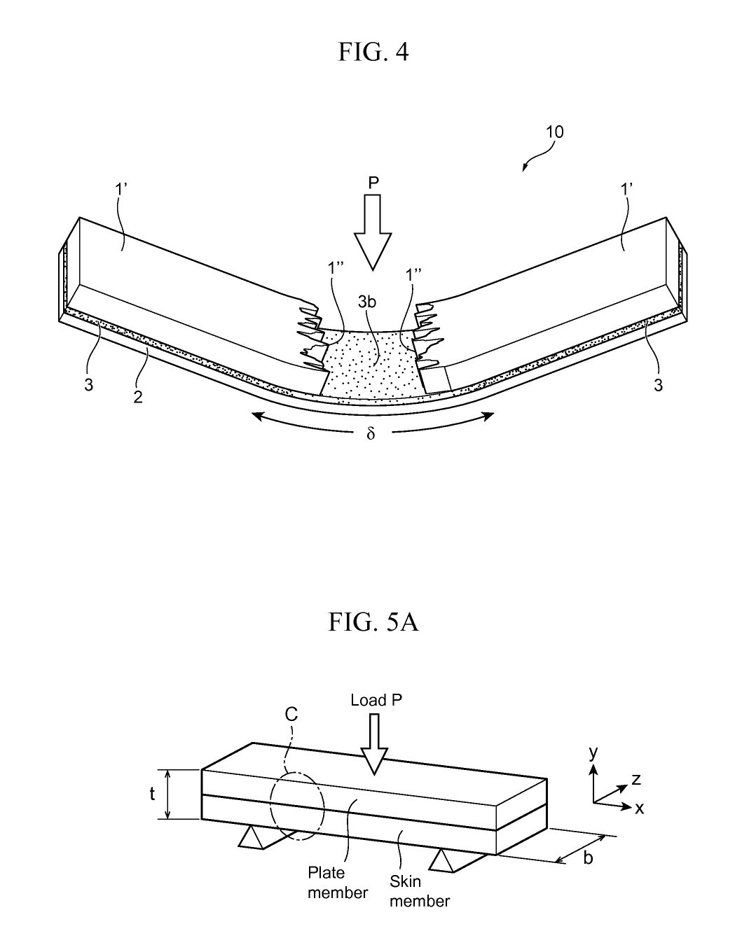

Referring next to FIG. 4, the following describes the state where load P acts on the center region of the resin laminated body 10 including the adhesion layer 3 according to Embodiment 1 of FIG. 2, and a breakage occurs at the resin plate member 1.

As illustrated in the drawing, when the load P acts on the center region of the resin laminated body 10, the resin laminated body 10 plastic-deforms at the center region, and after such plastic deformation progresses, the resin plate member 1 breaks so that the resin plate member is divided into two divided pieces 1′ each having an broken edge (sharp edge 1″).

The resin laminated body 10 illustrated is configured so that, when the resin plate member 1 breaks, the resin skin member 2 that is more stretchable easily peels off from the resin plate member 1 at the weak adhesiveness part 3b at a part corresponding to this breakage. In this way, the breakage of the resin plate member 1 does not cause a tear of the resin skin member 2, and the resin skin member 2 peels off from the resin plate member 1 speedily at the weak adhesiveness part 3b and is extended desirably, for example (the amount of extension 8).

That is, when the resin skin member 2 is located outside, the sharp edge 1″ of the divided piece 1′ is surrounded with the resin skin member 2, which can prevent the sharp edge 1″ from being exposed to the outside.

In this way, the resin laminated body 10 illustrated, which has a simple configuration including one resin skin member 2 bonded to the resin plate member 1 via the adhesion layer 3, can prevent the exposure to the outside of the sharp edge 1″ at a broken part with the resin skin member 2 effectively. Due to such a simple configuration, the manufacturing cost can be reduced, and the manufacturing efficiency can be increased.

The resin laminated body 10 can avoid the exposure of a sharp edge 1″ when the resin plate member 1 as its element is broken, and so can protect a passenger inside of the vehicle, and so is preferably applicable to an interior panel for vehicle, such as a front pillar, a roof side rail, or a front pillar garnish.

### (How to Calculate the Adhesiveness at a Weak Adhesiveness Part so as to Prevent the External Exposure of a Sharp Edge Generated at the Resin Skin Member)

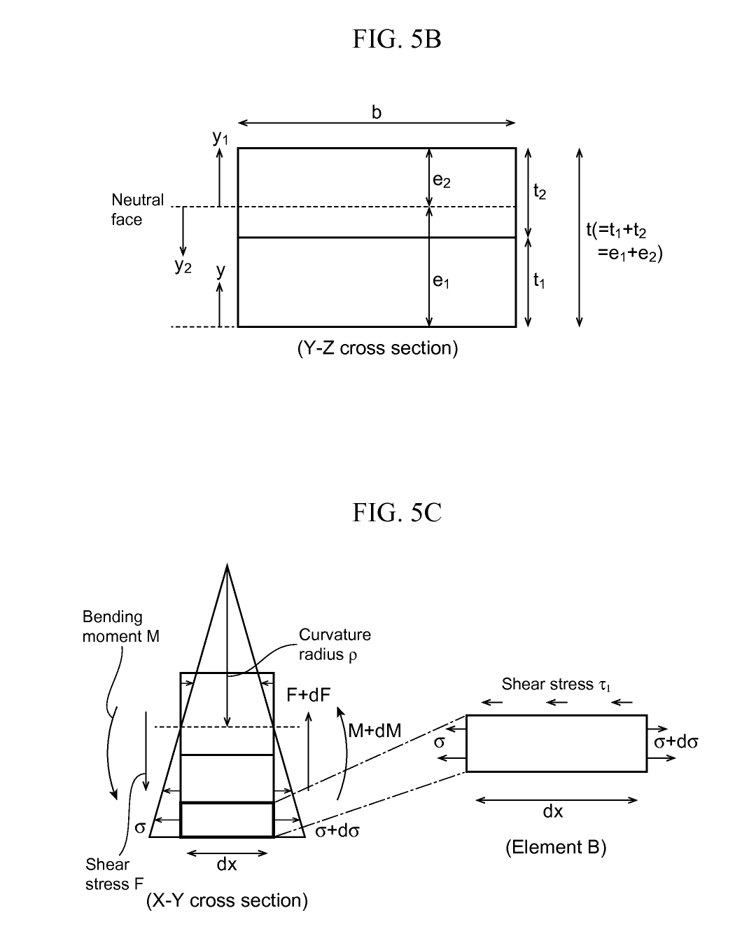

Referring now to FIGS. 5A, 5B and 5C, the following describes how to calculate dynamically the adhesiveness at a weak adhesiveness part so as to prevent the external exposure of a sharp edge generated at the resin skin member. FIG. 5A describes the state where a load acts on the center position of a verification model, FIG. 5B describes a y-z cross section of the verification model, and FIG. 5C describes a cross-sectional force at an x-y cross section of the verification model.

As illustrated in FIG. 5A, the verification model for the resin laminated body includes a resin plate member (Young's modulus E2) and a resin skin member (Young's modulus E1, where E1<E2) that are bonded integrally (the plate member has a thickness t2, the skin material has a thickness t1, and t denotes the overall thickness, b denotes width). Such a verification model is supported at two points, and a load P is placed on a center of the verification model. Then a cross-sectional force and a cross-section stress acting on the verification model are examined.

In the y-z cross section of the verification model in FIG. 5B, its neutral axis is located in the plate member at a position of e1 from the upper end and of e2 from the lower end.

Assume here that the y-z cross section keeps flat faces at the plate member and the skin member even after bending acts on the verification model, meaning that they are orthogonal to the axis line (neutral face) after being bent, i.e., assume the Bernoulli-Euler theory.

The total of the normal stress σ generated at the y-z cross section equals the axial force. Herein, no axial force acts on the verification model, meaning that the axial force is zero. That is, the following expression 1 holds:

$$\int σ d A = 0 \\ ∴ \int σ d A = {\int }_{0}^{t 1} \frac{E 1 ( y - e 1 )}{ρ} b d y + {\int }_{t 1}^{t} \frac{E 2 ( y - e 1 )}{ρ} b d y = 0 \\ ∴ {\int }_{0}^{t 1} E 1 ( y - e 1 ) d y + {\int }_{t 1}^{t} E 2 ( y - e 1 ) d y = 0 \\ ∴ E 1 ( \frac{1}{2} t {1}^{2} - e 1 t 1 ) + E 2 ( \frac{1}{2} {t}^{2} - e 1 t ) - E 2 ( \frac{1}{2} t {1}^{2} - e 1 t 1 ) = 0 \\ ∴ e 1 = \frac{( E 1 - E 2 ) t {1}^{2} + E 2 {t}^{2}}{2 \{ ( E 1 - E 2 ) t 1 + E 2 t \}} \qquad [ Expression 1 ]$$

Then the balancing of force at an element B that is taken out from the x-y cross section of FIG. 5C leads to the following expression 2:

$$- τ 1 b d x + {\int }_{- y 1}^{e 1} ( σ + d σ ) b d y 2 - {\int }_{- y 1}^{e 1} σ d y 2 = 0 \qquad [ Expression 2 ]$$

The stress σ can be represented by the following expression 3 based on the bending moment M and the second moment of area I:

$$σ = \frac{My 2}{I} , σ + d σ = \frac{( M + d M ) y 2}{I} \qquad [ Expression 3 ]$$

Based on expression 3, the shear stress τ1 can be represented by the following expression 4:

$$τ 1 = \frac{1}{I} \frac{d M}{d x} {\int }_{- y 1}^{e 1} y 2 d y 2 = \frac{1}{2 I} \frac{d M}{d x} ( e {1}^{2} - y {1}^{2} ) \qquad [ Expression 4 ]$$

Meanwhile, the shear force F can be represented by the following expression 5:

$$F = \frac{d M}{d x} = \frac{P}{2} \qquad [ Expression 5 ]$$

Based on expressions 4 and 5, τ1 can be represented by the following expression 6:

$$τ 1 = \frac{P}{4 I} ( e {1}^{2} - y {1}^{2} ) \qquad [ Expression 6 ]$$

The shear stress generated at the interface between the plate member and the skin member can be represented by the following expression 7:

$$y 1 = t 1 - e 1 \\ ∴ τ 1 = \frac{P}{4 I} \{ e {1}^{2} - {( t 1 - e 1 )}^{2} \} = \frac{P}{4 I} ( 2 e 1 t 1 - t {1}^{2} ) \qquad [ Expression 7 ]$$

The load Ps at the time of occurrence of a sharp edge because the plate member breaks is assigned in expression 7 to find the value of τ1s. Then, a weak adhesiveness part having adhesiveness of τ1s or less is disposed at a part where a sharp edge is expected (e.g., a center region of the member), whereby exposure of a sharp edge to the outside can be avoided.

That is a detailed description of the embodiments of the present invention with reference to the drawings, and the specific configuration is not limited to the above-stated embodiments, and it should be understood that we intend to cover by the present invention design modifications without departing from the spirits of the present invention.

### DESCRIPTION OF SYMBOLS

1, 1A Resin plate member
1a Projection
1′ Divided piece
1″ Sharp edge
2 Resin skin member
3, 3A, 3B Adhesion layer
3a, 3d Normal adhesiveness part
3b, 3c, 3e Weak adhesiveness part
10 Resin laminated body

1. A resin laminated body, comprising:
a resin plate member; and a resin skin member that is stretchable more than the resin plate member and is bonded to the resin plate member via an adhesion layer, wherein
the adhesion layer includes a weak adhesiveness part having a relatively small adhesiveness than other parts.

2. The resin laminated body according to claim 1, wherein the adhesion layer includes at least two types of adhesives, including an adhesive having a relatively large adhesiveness and an adhesive having a relatively small adhesiveness.

3. The resin laminated body according to claim 1, wherein the weak adhesiveness part includes a part where no adhesive is applied.

4. The resin laminated body according to claim 1, wherein the weak adhesiveness part is disposed at a part where the resin laminated body easily generates bending when undergoing bending deformation.

5. The resin laminated body according to claim 4, wherein the part where bending easily occurs includes at least a center region of the resin laminated body.

6. The resin laminated body according to claim 1, wherein the resin plate member includes a carbon fiber-reinforced resin member (CFRP).

7. The resin laminated body according to claim 1, wherein the resin laminated body includes an interior panel for vehicle.
